(19) United States
(12) Patent Application Publication
(10) Pub. No.: US 2012/0130756 A1
(43) Pub. Date: May 24, 2012

(54) AUGMENTATION OF A USER PARTICIPATION OF A SALES AND OPERATIONS PLAN THROUGH AN OFF THE SHELF SPREADSHEET APPLICATION WITH A PLUG-IN

(75) Inventors: CHANDRA P. AGRAWAL, Pleasanton, CA (US); Glen William Margolis, San Ramon, CA (US)

(73) Assignee: Steelwedge Software, Inc., Pleasanton, CA (US)

(21) Appl. No.: 12/951,080

(22) Filed: Nov. 22, 2010

(51) Int. Cl. G06Q 10/00

(52) U.S. Cl. 705/7.11

(57) ABSTRACT

In one embodiment, a method of a server device includes determining a date to send an e-mail alert based on a flexible calendar of a sales and operations plan. The method also includes recording a response of a user to the e-mail alert. The method further includes tracking a participation of the sales and operations plan based on the response of the user to the e-mail alert. The method also includes generating a report based on the participation. In addition, the method includes generating a reminder when the participation is below a threshold of the participation. The method also includes increasing the participation of the sales and operations plan such that a percentage of the response of the user is increased.

### FIELD OF TECHNOLOGY

This disclosure relates generally to a field of analysis of supply and demand planning and in an embodiment to a method, system and an apparatus for augmentation of a user participation of a sales and operations plan through an off the shelf spreadsheet application with a plug-in.

### BACKGROUND

Sales and operations planning may refer to the technologies, applications and/or processes of connecting the planning function across the enterprise to improve organizational alignment and financial performance. Deploying a sales and operations plan across the enterprise and leveraging the organization's information assets may assist corporate executives, business unit heads and planning managers to evaluate plans and activities based on economic impact and/or other considerations.

Sales and operations planning may require information from employees in different divisions and/or departments within the enterprise. There may be difficulties in the collection of the information. Employees may forget to enter the information. Additionally employees may have difficulty using and/or lack familiarity with the user interface and/or database software to enter the information. As a result the calculations of the sales and operations plan may not be complete, because it may not have the information needed. Enterprises may not be able to operate effectively and/or efficiently with incomplete information in the sales and operations plan.

### SUMMARY

Disclosed are a method, an apparatus, and/or a system for augmentation of a user participation of a sales and operations plan through an off the shelf spreadsheet application with a plug in.

In one aspect, a method of a server device includes determining a date to send an e-mail alert based on a flexible calendar of a sales and operations plan. The method also includes recording a response of a user to the e-mail alert. In addition, the method of server device includes tracking a participation of the sales and operations plan based on the response of the user to the e-mail alert. The method of server device also includes generating a report based on the participation. The method of server device further includes generating a reminder when the participation is below a threshold of the participation. The method of server device also includes increasing the participation of the sales and operations plan such that a percentage of the response of the user is increased.

The flexible calendar may be a calendar that is adjustable based on a process step. The process step may be one of a sales forecasting step, a demand planning step, a supply planning step, a reconciliation step, and a finalizing step. The reconciliation step may include matching a supply plan with a demand plan. The e-mail alert includes a unique identification such that the response of the user may be traceable based on the unique identification. The report of the participation of the sales and operations plan may be generated based on the unique identification.

The e-mail alert may be customizable based on a template. The template may include a link, the report, and a dashboard. The participation may be the percentage of the response of the user to the e-mail alert. The response to the e-mail alert may include an input of a data to the sales and operations plan. The report of the participation may be exception based such that the user is prompted to respond to an exception. The exception is a deviation from an expected value based on a calculation of the sales and operations plan.

The report of the participation may be presentable in a format including a list of the users that responded to the e-mail alert, a comparison of the participation of a first month with the participation of a second month, and the percentage of the response based on the process step. The reminder may be a notification to the user. The user may be reminded to respond to the e-mail alert.

The method may also include embedding the link to a spreadsheet program in the e-mail alert. The spreadsheet program may be available off the shelf. The method may further include creating a demand plan in a distributed cloud infrastructure based on a demand-forecasting algorithm that may consider multi-party input in client-side visualizations of a certain aspect of the demand plan appropriate to a demand-side stakeholder based on a rules-based algorithm that considers a demand-side access privilege and a demand-side role of the demand-side stakeholder.

In addition, the method may include creating a supply plan in the distributed cloud infrastructure based on another supply-forecasting algorithm that may consider multi-party input in client-side visualizations of a particular aspect of the supply plan appropriate to a supply-side stakeholder based on a rules-based algorithm that considers a supply-side access privilege and a supply-side role of the supply-side stakeholder. The method may also include determining that a set of processing units in the distributed cloud infrastructure may be available to process the demand plan and the supply plan.

The method may further include applying a planning algorithm using a combined processing power of available ones of the set of processing units in the distributed cloud infrastructure to create a build plan when the one or more of the demand plan and the supply plan may be processed in the distributed cloud infrastructure. The method may also include reverting to a dedicated server processing to create the build plan when the set of processing units in the distributed cloud infrastructure may be unavailable.

The method of server device in the form of a machine-readable medium embodying a set of instructions that, when executed by a machine may cause the machine to perform the method of server device.

In another aspect, a method of a client device includes processing an e-mail alert of a sales and operations plan based on a date based on a flexible calendar. The method of a client device also includes permitting a response of a user to the e-mail alert. In addition, the method of the client device includes responding to request of the user to the e-mail alert such that a participation of the sales and operations plan is traceable. The method of the client device also includes processing a report based on the participation.

The method of the client device further includes processing a reminder when the participation is below a threshold. The method of the client device also includes increasing the participation of the sales and operations plan such that a percentage of the response of the user is increased.

In yet another aspect, a system includes a server device to calculate a participation of a sales and operations plan. The system also includes a client device to process a request of a user such that the participation of the user is calculable. The system further includes an e-mail alert to collect the participation of the user. The system also includes a flexible calendar to determine a date of the e-mail alert. In addition, the system includes a reminder to remind the user to respond to the e-mail alert when the participation of the sales and operations plan is below a threshold. The system also includes an embedded spreadsheet coupled to the e-mail alert to permit the user to enter a data of the sales and operations plan.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic representation of a system illustrating sales and operations planning, according to one or more embodiments.

FIG. 2 is an exploded view of a sales and operations planning module of FIG. 1, according to one or more embodiments.

FIG. 3 is a user interface view illustrating assignment given to sales account executives, according to one or more embodiments.

FIG. 4 is a user interface view illustrating a report of the assignments received by manager, according to one or more embodiments.

FIG. 5 is a flexible calendar of sales and operations planning, according to one or more embodiments.

FIG. 6 is a schematic diagram of workflow in the system of sales and operations planning, according to one or more embodiments.

Other features of the present embodiments will be apparent from the accompanying drawings and from the detailed description that follows.

### DETAILED DESCRIPTION

Example embodiments, as described below, may be used for augmentation of a user participation of a sales and operations plan through an off the shelf spreadsheet application with a plug in. Although the present embodiments have been described with reference to specific example embodiments, it will be evident that various modifications and changes may be made to these embodiments without departing from the broader spirit and scope of the various embodiments.

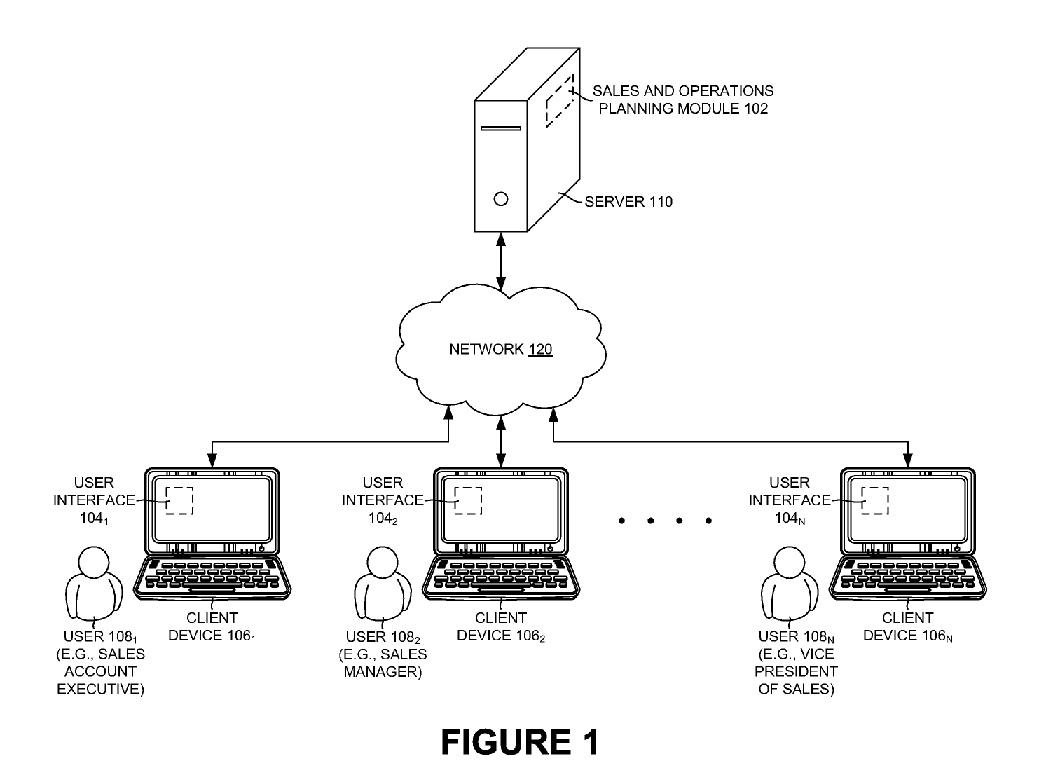

FIG. 1 is a schematic representation of a system of sales and operations planning, according to one or more embodiments. In one or more embodiments, the system as described herein includes a server 110, one or more of a client device 106_{1-N} communicatively coupled through a network 120.

In one or more embodiments, the server 110 may include a sales and operations planning module 102 configured in the server 110 and executed through a processor of the server 110. In one or more embodiments, the client devices 106_{1-N} may be configured to communicate with the server 110 through the network 120. Each of the client device communicates with the server 110 through an user interface provided thereof. In one or more embodiments, the client device(s) 106_{1-N} may be any of a thin and/or a fat client device. In one or more embodiments, examples of the client device may include, but is not limited to, a computer, a laptop, a mobile phone, etc.

In one or more embodiments, the user interface(s) 104_{1-N} in the client device(s) 106_{1-N} is configured to enable the user to communicate with the server 110 through the network 120. In one or more embodiments, the network 120 may be Wide Area Network (WAN), Local Area Network (LAN), etc. In one or more embodiments, the user(s) 108_{1-N} accessing the server 110 through the user interface(s) 104_{1-N} in the client device(s) 106_{1-N} may be sales account executives, sales manager, vice president of sales, etc. The server 110 may be configured to respond to the user(s) 108_{1-N} based on a profile of the user(s) 108_{1-N}. For example, the sales account executive would be provided with a response for sale related queries such projected target sale, items sold, etc. In another example, the vice president of sales would be provided with a response for that query on plans, projected sales, target sales and the like. Each of the user(s) 108_{1-N} may be provided with a profile and the server 110 may be configured to respond to each of the user based on the user profile. Each of the user(s) 108_{1-N} based on the profile may be provided with options such as access to files, type of user interface and other report generating options.

In one or more embodiments, the user interface(s) 104_{1-N} may be any of, but not limited to management interface, search entry navigation interface, etc. In one or more embodiments, the sales and operation planning module 102 of the server 110 may be configured to calculate a participation of a sales and operations plan. In one or more embodiments, based on a projected plan, the server 110 is configured to communicate a request to the user regarding a participation in sales and operations as per the projected plan. In one or more embodiments, the request may be an email alert and/or a Short Message Service (SMS). The date and time of the request may be determined based on the projected plan.

In one or more embodiments, the client device(s) 106_{1-N} of the user may be configured to process an email alert of a sales and operations plan. The user 108 may be enabled to preset schedules in the flexible calendar and the client device 106 of the user may be configured to process the email alert of a sales and operations plan. Alternatively, user 108 may also be permitted (e.g., allowed) to respond to the email alert or SMS. In one or more embodiments, the response may be communicated through an email or through an SMS. In one or more embodiments, the response may be provided to the server 110 through an email or an SMS alert such that a participation of the sales and operations plan based is traceable.

The user 108 upon receipt of the message may respond back with a response that includes confirmation information. The sales and operations planning module 102 of the server 110 may receive the response of the user 108 from the client device 106. Aforementioned process of communicating a request to the user 108 is performed with other users 108_{1-N} of the organization and responses from the users 108_{1-N} are collected.

Based on the responses obtained, the sales and operations planning module 102 of the server 110 calculates the participation of the sales and operations plan. Further, while executing the sales and operation plan, the sales and operations planning module 102 of the server 110 tracks the participation of the sales and operations plan. In addition, based on the confirmed participation determined from the responses of the users 108_{1-N}, a report may be generated based on the participation.

Further, the sales and operations planning module 102 of the server 110 may be configured to analyze the participation rate. If the participation is below a threshold, the sales and operations planning module 102 of the server 110 generates a reminder to participants (users) and managers regarding the participation being below the threshold. Furthermore, the participation of the sales and operations may be increased to ensure that the participation is above the threshold of participation. In one or more embodiments, the sales and operations planning module 102 of the server 110 participation may increase the participation by communicating a request for additional resources (e.g., non-participating users) and/or to the existing resources (e.g., participating but not available users) for participation in the sales and operations plan.

Also, the sales and operations planning module 102 of the server 110 may be configured to increase the participation even when there the participation is above the threshold of participation in order to boost the sales and operations. In one or more embodiments, the sales and operations plan may be generated through various inputs. In one or more embodiments, the inputs may include, but is not limited to a sales trend, a flexible calendar, history data, sales team input, market analysis and projected forecasts.

In one or more embodiments, the sales and operations planning module 102 of the server 110 may generate an embedded spreadsheet coupled to the e-mail alert. In one or more embodiments, the spreadsheet may be an electronic worksheet permitting the user(s) 108_{1-N} to enter a data of the sales and operations plan.

In one or more embodiments, the sales and operations planning module 102 may be an architecture designed using high level standard languages (e.g., Java) and databases (e.g., RDBMS, etc) for processing of data. In one or more embodiments, the sales and operations planning module 102 may include a unique data abstraction layer to carry out very high performance interactions with the database. In one or more embodiments, the sales and operations planning module 102 may include a data load processor designed for processing any type of data type at a relatively fast speed to deal with very large volume transactions associated with the sales and operations planning.

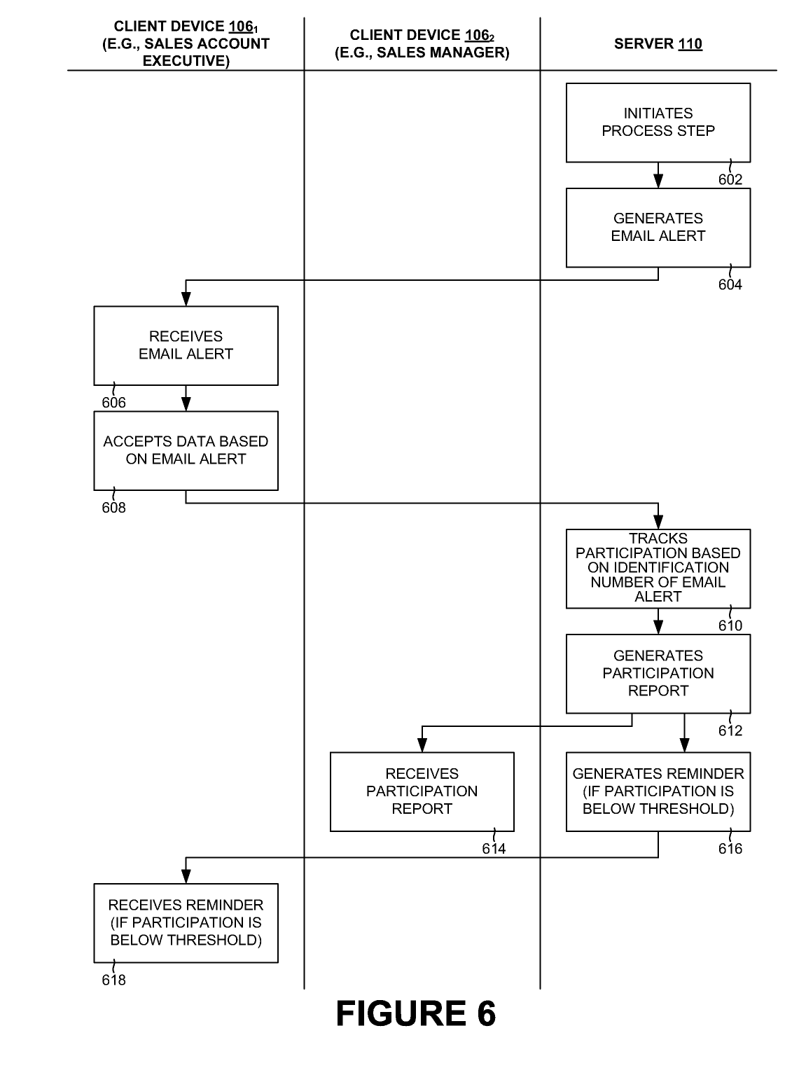

In one or more embodiments, the sales and operations planning module 102 may include a job manager framework designed to permit the user(s) 108_{1-N} to process user interactions in the background and act as an overall traffic cop to handle very high workloads. In one or more embodiments, the job manager may dynamically assist the server 110 during peak loads to reduce the load of the system. In one or more embodiments, the sales and operations planning module 102 may also include an algorithm designed as workflow (e.g., as illustrated in FIG. 6) to manage the processes of a sales and operation management.

In one or more embodiments, the sales and operations planning module 102 may also include a user security filter architecture designed to permit the user(s) 108_{1-N} to assign any type of portion of the work, product, etc. In one or more embodiments, the user(s) 108_{1-N} may have visibility only to the assigned part of work, product, etc. based on the profile of the user(s) 108_{1-N}.

In one or more embodiments, the sales and operations planning module 102 may include a filter manager designed to permit the user(s) 108_{1-N} to look at any unique combination of data within the application of sales and operations planning based on the profile of the user(s) 108_{1-N}. For example, the user(s) 108_{1-N} can look at the top 10 revenue gross regions in a product family. In one or more embodiments, the filter manager may be similar to a search function, capable of processing even numerical type of searches, computations, etc required for the demand planning, supply planning, sourcing, etc.

In one or more embodiments, the sales and operations planning module 102 may include aggregation and disaggregation logics built on top of the job manager designed to permit the user(s) 108_{1-N} to carry out responsibilities of sales and operations. In one or more embodiments, the functions may include, but not limited to, fair share, proportional overwrites, etc. In one or more embodiments, the sales and operations planning module 102 may also provide with a list manager to permit the user(s) 108_{1-N} to create different types of lists for managing different kinds of work (e.g., demand planning, supply planning, sales, etc).

For example, a list of the top 10 customers from the entire list of customers may be generated by the list manager based on the requirement of the user(s) 108_{1-N}. In another example, a list is generated for a user(s) 108_{1-N} where the user(s) 108_{1-N} may wish to see the list of customers whose three months revenue is 20% less than the past 3 months revenue. In one or more embodiments, the list generated may be automatically updated by the server 110 based on the requirements of the user 108_{1-N}.

In one or more embodiments, the sales and operations planning module 102 may also include an administrative user interface designed to carry out various functions. In one or more embodiments, the functions may include, but not limited to, sending notification e-mails, creating a backup of assignments and sending the assignments, assigning the access to a portion of the application of sales and operations planning, etc.

In one or more embodiments, the sales and operations planning module 102 may include template manager and worksheet generators which may be combination frameworks. In one or more embodiments, templates may be the views which are used to view the data within worksheet/spreadsheet. In one or more embodiments, the speadsheets/worksheets may be the instances of the templates. In one or more embodiments, the user(s) 108_{1-N} may manage the views, the order of time series that appear in the templates, etc.

In one or more embodiments, the sales and operations planning module 102 may also include a catalog manager interface which the user(s) 108_{1-N} can manage the data within the application. In one or more embodiments, the catalog manager may assist in mapping the data. In one or more embodiments, the user(s) 108_{1-N} may interact with the sales and operations planning module 102 through the web services and/or the web interface. In one or more embodiments, the web based user interface may be used for administrative purposes and to perform the search.

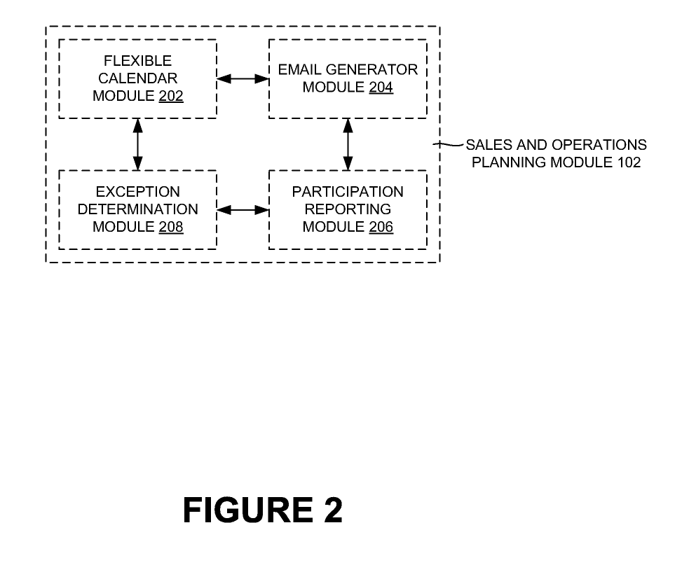

In one or more embodiments, the application of sales and operations planning may include an integration manager designed for mapping of any kind of data in any format. In one or more embodiments, mapping may result in a transformation map residing in the run time engine. In one or more embodiments, the application of sales and operations planning may also include a statistical forecast engine designed to permit the client device(s) 106_{1-N} to carry out predictive analysis using the respective algorithms on the data set. In one or more embodiments, the user(s) 108_{1-N} may access the data through the web and/or through a spreadsheet. In one or more embodiments, the sales and operations planning module 102 implemented in the server 110 of FIG. 1, is described in FIG. 2.

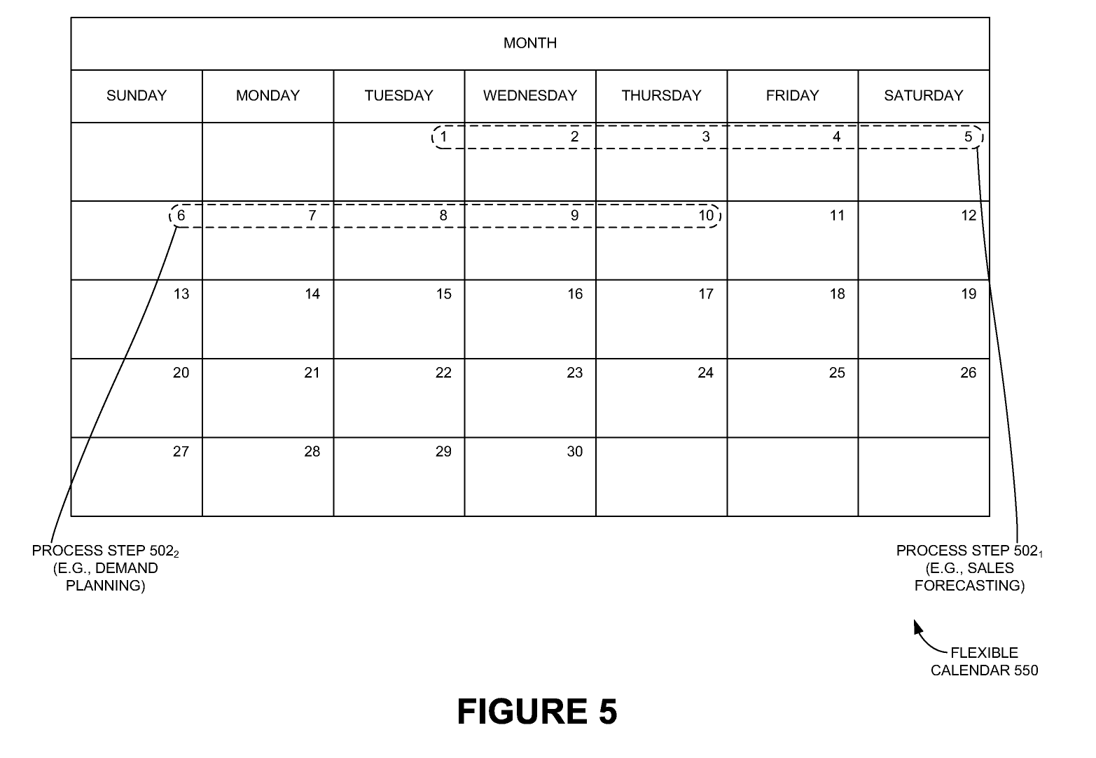

FIG. 2 is an exploded view of a sales and operations planning module 102 of FIG. 1, according to one or more embodiments. In one or more embodiments, the sales and operations planning module 102 implemented in the server 110 may include a flexible calendar module 202, an e-mail generator module 204, a participation reporting module 206, and an exception determination module 208. In one or more embodiments, the flexible calendar may be a calendar (e.g., as illustrated in FIG. 5). In one or more embodiments, the flexible calendar may be adjustable based on a process step. In one or more embodiments, the process step may be one of a sales forecasting step, a demand planning step, a supply planning step, a reconciliation step, and a finalizing step. The reconciliation step may include matching a supply plan with a demand plan.

In one or more embodiments, the e-mail generator module 204 of sales and operations planning module 102 may generate e-mail alerts. In one or more embodiments, the e-mail alert includes a unique identification such that the response of the user(s) 108_{1-N} may be traceable based on the unique identification. In one or more embodiments, based on the unique identification of the e-mail alert the report of participation of the sales and operations plan may be generated. In one or more embodiments, the e-mail alert may be customizable based on a template. The template may include a link, the report, and a dashboard.

In one or more embodiments, the participation reporting module 206 of the sales and operations planning module 102 may generate the participation as a percentage of the response of the user(s) 108_{1-N} to the e-mail alert. In one or more embodiments, the response to the email alert may be an input of a data to the sales and operations plan. In one or more embodiments, the report of the participation may be presentable in a format including a list of the user(s) 108_{1-N} that responded to the e-mail alert, a comparison of the participation of a first month with the participation of a second month, and the percentage of the response based on the process step.

In one or more embodiments, the report of participation may be exception based. In one or more embodiments, the user(s) 108_{1-N} may be prompted to respond to an exception. In one or more embodiments, the exception determination module 208 of the sales and operations planning module 102 may determine the exception as a deviation from an expected value based on the calculation of sales and operations plan.

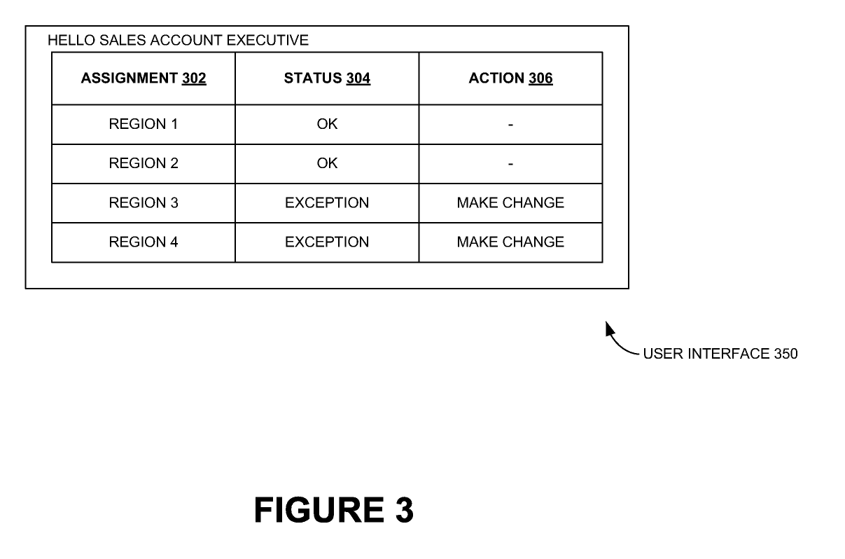

FIG. 3 is a user interface view illustrating an assignment target to sales account executives, according to one or more embodiments. For example, on a first day of a month notifications in the form of email alerts may be communicated to the client device (e.g., sales account executives). The email may include all the assignments assigned to a region (e.g., Region1, Region2, etc. as illustrated in FIG. 3). Eventually, when an assignment may be received, the account executives has to click on it to accept and update the status 304 (e.g., as illustrated in FIG. 3) as ‘OK’. In case the account executive does not accept the assignment then the case is considered as an ‘exception’. If the status 304 may be ‘OK’ then the spreadsheet need not be reviewed by the managers. In exception cases, the spreadsheet may be reviewed and the necessary changes are made (e.g., action 306 column as illustrated in FIG. 3). For example, the assignment may be divided and distributed to an other sales account executive.

As illustrated in FIG. 3, the assignments 302 given to the sales account executives of region 1 and region 2 were updated with the status 304 ‘OK’, hence requiring no further reviews and no further action 306 to make any changes. The sales account executives may agree with the forecast generated by the system (server device). The assignments 302 given to region 3 and region 4 were marked as ‘EXCEPTION’ in the status 304 column, hence requiring further reviews and changes.

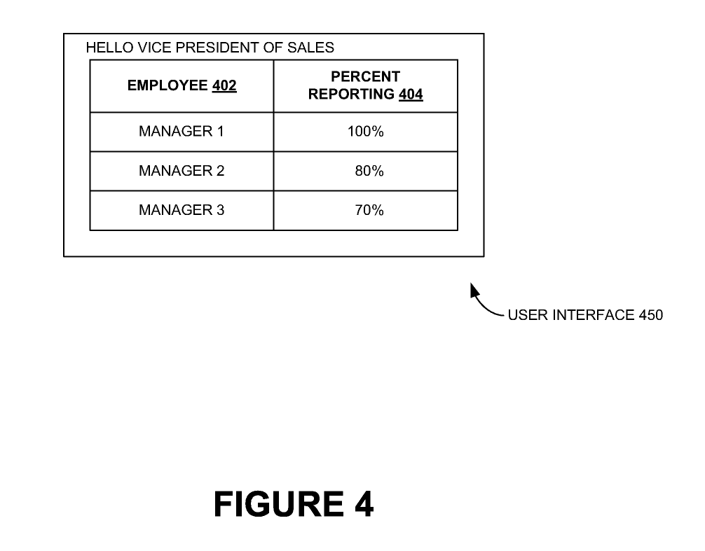

FIG. 4 illustrates a user interface displayed to a vice president of sales, according to one or more embodiments. In one or more embodiments, the assignments of the sales account executives of the regions may be sent to the respective managers. For example, manager 1 may have 3 sales account executives working under him. Manager 1 will get the report indicating that all the 3 sales account executives have reviewed the assignments (e.g., the forecast generated by the system); hence the report indicates 100%. For manager 2 the report received indicates 80% and for manager 3 the report received indicates 70% indicating some of the sales account executives have not completed their task or reviewed the assignment (e.g., the forecast generated by the system).

FIG. 5 illustrates a flexible calendar 550, according to one or more embodiments. FIG. 5 illustrates a calendar for a month. In one or more embodiments, the flexible calendar 550 may be provided by the sales and operation planning module of the server 110 to each of the user based on the user profile. For example, a flexible calendar for the manager may be a planning schedule, business schedule and the like. An example of a flexible calendar is illustrated herein.

The first 5 days of the month may be used for process step 502₁ (e.g., sales forecasting). The next 5 days of the month may be used for the process step 502₂ (e.g., demand planning). In one or more embodiments, a supply plan may be created in the distributed cloud infrastructure based on another supply-forecasting algorithm that may consider multi-party input in client-side visualizations of a particular aspect of the supply plan appropriate to a supply-side stakeholder based on a rules-based algorithm that considers a supply-side access privilege and a supply-side role of the supply-side stakeholder.

In one or more embodiments, a demand plan may be created in a distributed cloud infrastructure based on a demand-forecasting algorithm that considers multi-party input in client-side visualizations of a certain aspect of the demand plan appropriate to a demand-side stakeholder based on a rules-based algorithm that considers a demand-side access privilege and a demand-side role of the demand-side stakeholder. In one or more embodiments, the application of sales and operations planning may use workflows to provide escalations and reminders for the user(s) 108_{1-N}

In one or more embodiments, email communication (e.g., or SMS) may be the communication medium with the application where the reminders are sent. In one or more embodiments, the emails may include hyperlinks to direct the user to a particular webpage. For example, the user may click on the hyperlinks and to review and complete the forecast generated by the sales and operations planning module 102 implemented in the server 110. This may result in the managers' knowledge that the sales or the demand planning cycle can be closed since all the employees have submitted their forecast.

In one or more embodiments, determining a set of processing units in the distributed cloud infrastructure may be available to process the demand plan and the supply plan. In one or more embodiments, a planning algorithm may be applied using a combined processing power of available ones of the set of processing units in the distributed cloud infrastructure to create a build plan when the one or more of the demand plan and the supply plan is processed in the distributed cloud infrastructure. In one or more embodiments, reverting to a dedicated server processing to create the build plan when the set of processing units in the distributed cloud infrastructure may be unavailable.

FIG. 6 illustrates a schematic diagram of workflow in the system of sales and operations planning, according to one or more embodiments. As illustrated in the FIG. 6, in operation 602, the server 110 may initiate a process step. In one or more embodiments, the process step may be sales forecasting, demand planning, etc and generate assignments. In one or more embodiments, in operation 604, the server 110 generates e-mail alerts (or SMS) of the assignments and may communicate the generated email alerts to the client device(s) 106_{1-N}. (e.g., the client device 106₁ sales account executive as illustrated in FIG. 6). In one or more embodiments, in operation 606, the client device(s) 106_{1-N} (e.g., client device 106₁ sales account executive, as illustrated in FIG. 6) receives the e-mail alert. In one or more embodiments, in operation 608, the client device(s) 106_{1-N} (e.g., client device 106₁ sales account executive, as illustrated in FIG. 6) may accept data based on the e-mail alert (e.g., review the forecast) and communicates the data to the sales and operation planning module 102 of the server 110.

In one or more embodiments, in operation 610, the sales and operation planning module 102 of the server 110 may track participation based on the identification number of e-mail alert. In one or more embodiments, in operation 612, the sales and operation planning module 102 of the server 110 may generate the participation report to communicate the report to the client device(s) 106_{1-N} (e.g., the client device 106₂ of the sales manager, as illustrated in FIG. 6). In one or more embodiments, in operation 614, the client device(s) 106_{1-N} (e.g., client device 106₂ of the sales manager, as illustrated in FIG. 6) may receive the participation report. In one or more embodiments, the sales and operation planning module 102 of the server 110 may generate reminders if participation is below threshold (e.g., as illustrated in operation 616) and communicate the reminders to the client device 106₁. In one or more embodiments, in operation 618, the client device 106₁ may receive the reminder if the participation is below threshold. In one or more embodiments, the participation of the sales and operations plan may be increased beyond the threshold of participation.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer device), and may be performed in any order (e.g., including using means for achieving the various operations). Accordingly, the specification and drawings are to be regarded in an illustrative rather than a restrictive sense.

What is claimed is:

1. A method of a server device comprising:
determining, through a processor, a date to send an email alert based on a flexible calendar of a sales and operations plan;
recording a response of a user to the email alert;
tracking a participation of the sales and operations plan based on the response of the user to the email alert;
generating a report based on the participation;
generating a reminder when the participation is below a threshold of the participation; and
increasing the participation of the sales and operations plan such that a percentage of the response of the user is increased.

2. The method of claim 1 wherein:
the flexible calendar is a calendar that is adjustable based on a process step;
the sales and operations plan is a sales and operations plan; and
the process step is one of a sales forecasting step, a demand planning step, a supply planning step, a reconciliation step, and a finalizing step, wherein the reconciliation step comprises matching a supply plan with a demand plan.

3. The method of claim 2 wherein:
the email alert comprises a unique identification such that the response of the user is traceable based on the unique identification and such that the report of the participation of the sales and operations plan is generated based on the unique identification.

4. The method of claim 3 wherein:
the email alert is customizable based on a template, wherein the template comprises a link, the report, and a dashboard.

5. The method of claim 4 wherein:
the participation is the percentage of the response of the user to the email alert; and
the response to the email alert comprises an input of a data to the sales and operations plan.

6. The method of claim 5 wherein:
the report of the participation is exception based such that the user is prompted to respond to an exception; and
the exception is a deviation from an expected value based on a calculation of the sales and operations plan.

7. The method of claim 6 wherein:
the report of the participation is presentable in a format comprising a list of the user that responded to the email alert, a comparison of the participation of a first month with the participation of a second month, and the percentage of the response based on the process step.

8. The method of claim 7 wherein:
the reminder is a notification to the user such that the user is reminded to respond to the email alert.

9. The method of claim 8 further comprising:
embedding the link to a spreadsheet program in the email alert, wherein the spreadsheet program is available off the shelf.

10. The method of claim 9 further comprising:
creating a demand plan in a distributed cloud infrastructure based on a demand-forecasting algorithm that considers multi-party input in client-side visualizations of a certain aspect of the demand plan appropriate to a demand-side stakeholder based on a rules-based algorithm that considers an demand-side access privilege and a demand-side role of the demand-side stakeholder;
creating a supply plan in the distributed cloud infrastructure based on a supply-forecasting algorithm that considers multi-party input in client-side visualizations of a particular aspect of the supply plan appropriate to a supply-side stakeholder based on a rules-based algorithm that considers a supply-side access privilege and a supply-side role of the supply-side stakeholder;
determining that a set of processing units in the distributed cloud infrastructure is available to process the demand plan and the supply plan;
applying a planning algorithm using a combined processing power of available ones of the set of processing units in the distributed cloud infrastructure to create a build plan when the at least one of the demand plan and the supply plan is processed in the distributed cloud infrastructure; and
reverting to a dedicated server processing to create the build plan when the set of processing units in the distributed cloud infrastructure is unavailable.

11. The method of claim 1 in the form of a machine-readable medium embodying a set of instructions that, when executed by a machine, cause the machine to perform the method of claim 1.

12. A method of a client device comprising:
processing an email alert of a sales and operations plan based on a date based on a flexible calendar;
permitting a response of a user to the email alert;
responding to request of the user to the email alert such that a participation of the sales and operations plan based is traceable;
processing a report based on the participation;
processing a reminder when the participation is below a threshold of the participation; and
increasing the participation of the sales and operations plan such that a percentage of the response of the user is increased.

13. The method of claim 12 wherein:
the flexible calendar is a calendar that is adjustable based on a process step;
the sales and operations plan is a sales and operations plan; and
the process step is one of a sales forecasting step, a demand planning step, a supply planning step, a reconciliation step, and a finalizing step, wherein the reconciliation step comprises matching a supply plan with a demand plan.

14. The method of claim 13 wherein:
the email alert comprises a unique identification such that the response of the user is traceable based on the unique identification and such that the report of the participation of the sales and operations plan is generated based on the unique identification.

15. The method of claim 14 wherein:
the email alert is customizable based on a template, wherein the template comprises a link, the report, and a dashboard.

16. The method of claim 15 wherein:
the participation is the percentage of the response of the user to the email alert; and
the response to the email alert comprises an input of a data to the sales and operations plan.

17. The method of claim 16 wherein:
the report of the participation is exception based such that the user is prompted to respond to an exception; and
the exception is a deviation from an expected value based on a calculation of the sales and operations plan.

18. The method of claim 17 wherein:
the report of the participation is presentable in a format comprising a list of the user that responded to the email alert, a comparison of the participation of a first month with the participation of a second month, and the percentage of the response based on the process step.

19. The method of claim 18 wherein:
the reminder is a notification to the user such that the user is reminded to respond to the email alert.

20. A system comprising:
a server device to calculate a participation of a sales and operations plan;
a client device to process a request of a user such that the participation of the user is calculable;
an email alert to collect the participation of the user;
a flexible calendar to determine a date of the email alert;
a reminder to remind the user to respond to the email alert when the participation of the sales and operations plan is below a threshold; and
an embedded spreadsheet coupled to the email alert to permit the user to enter a data of the sales and operations plan.
